(19) United States
(12) Patent Application Publication
(10) Pub. No.: US 2026/0333133 A1
(43) Pub. Date: Oct. 22, 2026

(54) CENTRALLY MANAGED END USER CONTROLLED QUALITY OF SERVICE FOR 3GPP NETWORKS

(71) Applicant: Elisa Oyj, Helsinki (FI)

(72) Inventor: Jari SALO, Helsinki (FI)

(73) Assignee: Elisa Oyj, Helsinki (FI)

(21) Appl. No.: 19/469,249

(22) PCT Filed: Mar. 5, 2024
(86) PCT No.: PCT/FI2024/050087

§ 371 Date: Sep. 25, 2025

(30) Foreign Application Priority Data
May 30, 2023 (FI) 20235603

(51) Int. Cl. H04W 28/24; H04W 8/20; H04W 84/04

(52) U.S. Cl. CPC H04W 28/24; H04W 8/205; H04W 84/042

(57) ABSTRACT

A method including receiving, a request message (M1.2, M3.2A-B), from an User Equipment, UE, operating in an operator's network via a User Plane Function, UPF, by a Quality Assurance Server, QAS, residing in a network which is separate from the operator's network, reachable by the UE, to request a change in a Quality of Service, QoS, profile currently provided to the UE; identifying, a subscriber and the UE based on a Generic Public Subscriber Identifier, GPSI associated with the UE; creating a new QoS profile by comparing the request message and the currently provided QoS profile for the UE of the subscriber; and sending a response message (M1.4, M2.4, M3.4A-B) comprising the new QoS profile, by QAS to a Network Exposure Function, NEF, to trigger requested change in operator's network.

### TECHNICAL FIELD

The present disclosure relates to methods for centrally managing end user controlled quality of service for 3GPP networks. Moreover, the present disclosure relates to systems for centrally managing end user controlled quality of service for 3GPP networks.

### BACKGROUND

With the advancement in technology, mobile networks have evolved to fifth-generation (5G) technology. Ideally, the mobile network should be such that all devices and applications, which are a part of the mobile network, provides a seamless experience. Here, the role of Quality of Service (Qos) comes to play, wherein the QoS gives a measurement of an overall performance of a service experienced by all the devices and the applications. Conventionally, the 5G system (5GS) is enables fine-grained Quality of Service (QoS) at a user level or an application level.

Existing techniques and equipment are inadequate in terms of providing the seamless experience. In the current state-of-the-art, a change in the QoS is triggered by the core network of an operator providing services and hence requires cumbersome configuration in the core network, wherein the change in the QoS needs to be performed separately for each device or each application. Hence, this approach does not scale easily to real-world scenarios. Furthermore, the core network of the operator configures the Internet Protocol (IP) packet filters which are specific to each of the application in order to trigger a change in the QoS. However, from a point of view of providing services, such technique to trigger the change in the QoS is impractical, as a number of applications used by the users associated with the devices is high. Moreover, a developer of a certain application desirous of offering an elevated QoS to the users associated with the devices would need to make QoS-related agreements separately with every operator of the core network. This is quite a resource-intensive and a time-consuming process.

Therefore, in light of the foregoing discussion, there exists a need to overcome the aforementioned drawbacks.

### SUMMARY

The aim of the present disclosure is to provide methods and systems to facilitate initiation of a Quality of Service (QoS) profile by the end user in a reliable, resource-efficient and time-efficient manner. The aim of the present disclosure is achieved by methods and systems for centrally managing end user controlled Quality of Service for 3GPP networks. as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 is a schematic illustration of an environment in which a system is used, in accordance with an embodiment of the present disclosure;

FIG. 2 is a schematic illustration of an environment in which a system is used, in accordance with another embodiment of the present disclosure;

FIG. 3 is a schematic illustration of an environment comprising a plurality of operator networks in which a system is being used, in accordance with another embodiment of the present disclosure;

FIG. 4 illustrate steps of a method for centrally managed end user controlled quality of service, in accordance with an embodiment of the present disclosure;

FIG. 5 illustrate steps of a method for centrally managed end user controlled quality of service, in accordance with another embodiment of the present disclosure; and

FIG. 6 shows a sequence diagram illustrating operational steps of an exemplary system.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a method comprising:
receiving, a request message, from a User Equipment, UE, operating in an operator's network via a User Plane Function, UPF, by a Quality Assurance Server, QAS, residing in a network which is separate from the operator's network, reachable by the UE, to request a change in a Quality of Service, Qos, profile currently provided to the UE;
identifying, based on the request message, a subscriber and the UE based on a Generic Public Subscriber Identifier, GPSI, associated with the UE;
creating a new QoS profile based on the request message, by comparing the request message and the currently provided QoS profile for the UE of the subscriber; and
sending a response message, the response message comprising the new QoS profile for the UE of the subscriber, by the QAS to a Network Exposure Function, NEF, to trigger the requested change in the operator's network.

In the aforementioned method, the QoS currently provided to the UE can be dynamically changed upon request by the UE to the QAS. Hence, a control of changing the currently provided QoS is transferred to the end user, and thus can be triggered only once per operator's network. Advantageously, the request message for changing the QoS profile currently provided to the UE, is sent by the UE itself, which requires a network configuration which is less cumbersome than a conventional network configuration. Furthermore, the requested change in the QoS for the UE could be for a predetermined time and can be applied to all traffic originating from the UE or destined to the UE. This manner of changing the QoS currently provided to the UE is enabled synergistically by the aforementioned processing steps, since they facilitate in ensuring that the requested change in the QoS profile is implemented on the UE in real time or near-real time, by configuring the QAS. Beneficially, the QAS is used to centrally manage the requested change in the QoS profile, thereby preventing a need to contact every operator's network where the UE might be operating at. Beneficially, the requested change in the QoS profile is triggered for all applications in the UE. The method is simple, robust, fast, reliable and can be implemented with ease.

In a second aspect, the present disclosure provides a method comprising:
receiving, a request message, from an Application Server by a Quality Assurance Server, QAS, the Application Server and the QAS residing in a same network, the Application Server having an information on a single application or a group of applications, running in a UE operating system, to request a change in a Quality of Service, QoS, profile currently provided to a User Equipment, UE;
identifying, based on the request message, a subscriber and the UE based on a Generic Public Subscriber Identifier, GPSI, associated with the UE;
creating a new QoS profile based on the request message, by comparing the request message and currently provided QoS profile for the UE of the subscriber; and
sending a response message, the response message comprising the new QoS profile for the UE of the subscriber, by the QAS to a Network Exposure Function, NEF, to trigger the requested change in the operator's network.

In the aforementioned method, the QoS currently provided to the UE can be triggered by the Application Server, and not the UE. Beneficially, this provides a high QoS upon using the single application or the group of applications automatically, thereby enabling an engaging experience with negligible latency issues. This manner of changing the QoS currently provided to the UE is enabled synergistically by the aforementioned processing steps, since they facilitate in ensuring that the requested change in the QoS profile is implemented on the UE in real time or near-real time. Beneficially, upon detection of insufficient QoS by the Application Server, the request message is sent by said Application Server to the QAS, which in turn initiates a flow of the request message towards the operator's network to trigger the requested change. This is a time-efficient process, as the QAS and the Application Server reside in the same network, and the QAS need not be in direct contact with the NEF of every operator's network where the UE might be residing. The method is simple, robust, fast, reliable and can be implemented with ease.

In a third aspect, the present disclosure provides a system comprising a Quality Assurance Server, QAS, that is communicably coupled to a User Equipment, UE, operating in an operator's network, the QAS residing in a network which is separate from the operator's network, reachable by the UE, wherein the QAS is configured to:
receive a request message from the UE via a User Plane Function, UPF, to request a change in a Quality of Service, QoS, profile currently provided to the UE;
identify, based on the request message, a subscriber and the UE based on a Generic Public Subscriber Identifier, GPSI, associated with the UE;
create a new QoS profile based on the request message, by comparing the request message and the currently provided QoS profile for the UE of the subscriber; and
send a response message, the response message comprising the new QoS profile for the UE of the subscriber, to a Network Exposure Function, NEF, to trigger the requested change in the operator's network.

In the aforementioned system, a request to change the QoS of the UE dynamically can be triggered directly by the UE and sent to the QAS. Herein, a configuration of the network where the QAS resides in facilitates receiving the request message directly from the UE and triggers the change in the QoS service currently provided to the UE, based on a location of the UE. The QAS, due to its presence in the network, is highly responsive and has low-latency, which facilitates in dynamically changing the QoS profile of the UE. This manner of dynamically changing the QoS profile currently provided to the UE is enabled synergistically by configuring the QAS in such a manner that said QAS facilitates in ensuring that the requested change in the QoS profile is implemented on the UE in real time or near-real time in a time-efficient manner. Hence, this ceasing a need to contact the NEF of every operator's network where the UE might be residing. The aforementioned system is easy to implement, robust, simple and reliable, while being highly efficient at providing the requested QoS change, thereby enhancing an experience of any user associated with the UE.

In a fourth aspect, the present disclosure provides a system comprising a Quality Assurance Server QAS, wherein the QAS is configured to:
receive a request message from an Application Server, wherein the QAS and the Application Server reside in a same network, the Application Server comprising an information on a single application or a group of applications, running in an operating system of the UE, to request a change in a Quality of Service QoS profile currently provided to the UE;
identify, based on the request message, a subscriber and the UE based on a Generic Public Subscriber Identifier GPSI associated with the UE;
create a new QoS profile based on the request message, by comparing the request message and currently provided QoS profile for the UE of the subscriber; and
send a response message, the response message comprising the new QoS profile for the UE of the subscriber, to a Network Exposure Function NEF, to trigger the requested change in the operator's network.

In the aforementioned system, a request to change the QoS of the UE dynamically can be triggered directly by the Application server and sent to the QAS. Herein, a configuration of the network where the QAS resides in facilitates receiving the request message directly from the Application Server and triggers the change in the QoS service currently provided to the UE, based on a location of the UE. The Application server resides in the same network as the QAS, wherein the network is highly responsive and has low-latency, which facilitates in dynamically changing the QoS profile of the UE. This manner of dynamically changing the QoS profile currently provided to the UE is enabled synergistically by configuring the QAS in such a manner that said QAS facilitates in ensuring that the requested change in the QoS profile is implemented on the UE upon receiving the request message from the Application Server in real time or near-real time in a time-efficient manner. Hence, the QAS need not be in direct contact with the NEF of every operator's network where the UE might be residing. The aforementioned system is easy to implement, robust, simple and reliable, while being highly efficient at providing the requested QoS change, thereby enhancing an experience of any user associated with the UE.

Throughout the present disclosure, the term “user equipment” relates to an electronic device associated with (or used by) by a user that is capable of enabling the user to perform specific tasks associated with the aforementioned method. Furthermore, the user equipment (UE) is intended to be broadly interpreted to include any electronic device that may be used for voice and/or data communication over a wireless communication network. Examples of the UE include, but are not limited to, cellular phones, personal digital assistants (PDAs), handheld devices, wireless modems, laptop computers, personal computers, etc. Additionally, the UE includes a casing, a memory, a processor, a network interface card, a microphone, a speaker, a keypad, and a display.

The UE operates in the operator's network, wherein an infrastructure of the operator's network facilitates wired and/or wireless communication services to the UE, and wherein the UE is compatible with the operator's network to allow such communication. Optionally, the infrastructure of the operator's network comprises various components, for example, a base station, a switching centre, a transmission link, a router, an equipment to transport voice and/or data. Such components are connected to each other in a wired manner and/or a wireless manner, by using at least one of: a fibre optic cable, a radio wave, a satellite link, and the like.

The operator's network comprises the User Plane Function (UPF), wherein the UPF emulates a point of interconnection between the UE and the QAS. A technical effect of forwarding the request message in such a manner is that it establishes communication between the UE and the QAS through the UPF, thereby demonstrating interoperability between different network elements to ensure seamless communication. In this regard, the UPF forwards the request message from the UE to the QAS, optionally, based on policies and/or rules defined by the operator's network. A technical effect of forwarding the request message from the UE to the QAS in such a manner is that it enables authentication and validation of the request message, thereby ensuring security and integrity of the communication.

Optionally, the UPF has at least one feature which is used to implement the change in the QoS profile, wherein the at least one feature includes at least one of: a traffic detection and filtering feature, a traffic routing feature, a traffic optimization feature, a traffic shaping feature.

The Quality Assurance Server (QAS) is a centrally managed server which resides in the network which is separate from the operator's network, and reachable by the UE. Herein, such separation prevents interference of any undergoing process in the QAS with another process in the operator's network. The QAS is used for implementing the requested change in the QoS profile, and to provide the new QoS profile to the UE which has sent the request message. A technical effect of the QAS residing in the network which is separate from the operator's network is that it helps in preventing interference of any undergoing process in the QAS with another process in the operator's network. Furthermore, this provides a seamless operation of the QAS when undergoing a process. Moreover, it facilitates an initiation of the QoS profile by the end user in a reliable, resource-efficient and time-efficient manner.

In an embodiment, the network is a fifth-generation (5G) network. In another embodiment, the network is any one of: a public internet, a private internet. Optionally, the QAS is further configured to maintain a database of pre-configured QoS profiles for a plurality of NEFs of a plurality of operator's networks.

It will be appreciated that the term “Quality of Service” refers to a set of techniques used to manage network resources by the QAS, and ensure that data is delivered to the UE in a reliable and an efficient manner, wherein delivery of said data depends on the QoS profile currently provided to the UE. In other words, the Quality of Service (QoS) is used to prioritize a network traffic for the UE over another network traffic of another UE, to ensure that the UE seeking a change in the QoS receives at least one of: a bandwidth, a resource, to function as per requirement. Examples of such network traffic may include, but are not limited to, a voice traffic, a video traffic, data traffic, and similar. Examples of the set of techniques used to manage network resources by the QAS may include, but are not limited to, a traffic shaping technique, a bandwidth allocation technique, a packet prioritization technique, and a congestion avoidance technique.

Moreover, the term “QoS profile” refers to attributes of the service currently provided to the UE, or to be dynamically changed for the UE, wherein said attributes define a level of QoS that is to be provided to the network traffic of the UE within the operator's network, which can then be used to prioritize certain types of flows of the network traffic over others based on a requirement of a service or an application being used on the UE. Optionally, the attributes available in the QoS profile comprises at least one of: a traffic class, a bandwidth allocation, a priority level, a predefined latency level, a predefined jitter level, a predefined level of packet loss, at least one rule for traffic shaping and/or policy. The QoS profile depends on several factors, for example, such as, network congestion, a type of service being used, a type of application being used, a location of the UE, and the QoS profile assigned by the operator's network. For example, the QoS profile currently provided to the UE may be based on low network congestion, such that when there is heavy network congestion, the request message may be sent to the QAS to change the QoS profile to provide a better experience to a user associated with the UE.

Throughout the present disclosure, the term “request message” refers to a message sent from the UE to the QAS in order to initiate a request to change the QoS profile in the operator's network where the UE resides therein. Optionally, contents of the request message comprises at least one of: a destination IP address, an identity (ID) of the UE, a data network name (DNN), the GPSI of the UE, a Public Land Mobile Network identifier (PLMN ID), a location information (LocationInfo) of the UE, an Internet Protocol Version Four (IPV4) address of the UE for said DNN, a reflective QoS supported by the UE, a requested time period for higher QoS, a sponsor information (SponsorInfo), a notification destination. Herein, when contents of the request message are not available, default values can be substituted by the QAS upon receiving said request message. As a first example, the request message may be sent by the UE to provide a QoS higher than the QoS being currently provided to the UE, wherein the UE may be engaged in gaming and experiencing latency issues during said gaming. The request message is sent to change the currently provided QoS profile to a new QoS profile wherein the high QoS may be provided to the user for one hour. The request message may comprise, the destination IP address may be an IP address of the QAS, the ID of the UE may be a Mobile Station Integrated Services Digital Network (MSISDN) of the UE, the DNN may be ‘internet’, the GPSI of the UE may be the MSISDN of the UE, the PLMN ID may be the mobile country code that may be ‘244’ and the mobile network code that may be ‘05’, the LocationInfo of the UE may be a 5GCell ID of the UE, the IPV4 address of the UE for said DNN may be ‘10.10.10.10’, the reflective QoS supported by the UE may be ‘true’, the requested time period for higher QoS may be ‘1 hour’, the SponsorInfo may be ‘self-paid’, the notification destination may be ‘https://10.10.10.10:7070/notifications/v1/sessionid/123498765123’.

Optionally, a format of the request message follows a syntax of a representational state transfer (REST) application programming interface (API) design guidelines for the network. An example of the format of the request message is provided in the Appendix hereinbelow.

Optionally, the request message indicates a single application or a group of applications, running in an operating system of the UE. Herein, the single application or the group of applications may be present within a work profile, which could be a preconfigured QoS profile requested from the QAS. Herein, the single application or the group of applications reside in the network where the QAS is residing. A technical effect of the single application or the group of applications running in the operating system of the UE is that the QAS is configured to hide details related to the NEF and maintain QoS profiles available per operator's network, thereby ceasing a need to make any changes to the single application or the group of applications which are specific to the operator's network.

Optionally, the operating system of the UE is required to support an application identity (ID) feature of the operating system for when the network is configured to allow for multiple networks to be created using an infrastructure of the network where the QAS is residing (commonly known as, network slices). Moreover, an operating system application identifier could be included when the requested QoS change is for the single application or a group of applications. Herein, the requested change in the QoS profile currently provided to the UE can be implemented by various techniques available under QoS provided by the 5G network. Examples of such techniques may include, but are not limited to, a guaranteed bit rate technique, network slice guaranteed bandwidth technique, and a 5G quality indicator technique. Examples of the applications may include, but are not limited to, a company virtual private network (VPN) traffic, a real-time collaborative workspace, and a streaming service. Examples of the operating system may include, but are not limited to, Android®, Apple IOS®, and Microsoft Windows 11®.

An example of the request message indicating the single application or the group of applications is provided in the Appendix hereinbelow.

Continuing in reference to the first example, there may be an application running in the operating system of the UE, wherein said application may be a “turbo” option, which may be provided on an interactive user interface associated with the UE in a form of a button. Hence, the request message may further comprise a reference to the pre-configured QoS profile “turbo”.

Optionally, the network the QAS is residing in is a 3rd Generation Partnership Project, a 3GPP, network that supports the NEF (as will be described later). It will be appreciated that the 3GPP network is based on standards and specifications developed by the 3GPP, wherein the 3GPP is a collaboration between telecommunication standards organizations that works to develop global standards for technologies in mobile communication. Herein, the QAS resides in the 3GPP network to ensure that the QoS provided by the QAS is up to the standards and the specifications of the 3GPP network. A technical effect of the QAS residing in the 3GPP network is that the QAS is able to access real-time data directly from network elements of the 3GPP network which allows for real-time monitoring of performance of the network, provides seamless integration with network management systems associated with the 3GPP network, and maintains the change in the QoS profile (as requested by the request message) compliant with the standards and the specifications of the 3GPP network.

The request message comprises the GPSI, wherein the GPSI is a unique identifier used in the operator's network to identify a group of subscribers having common factors. In other words, the GPSI is the operator's network-specific identifier that represents the subscriber in a generic and a public manner, wherein the GPSI is typically assigned to the operator's network. Herein, the GPSI is specified in a technical specification of the 3GPP network (commonly known as 3GPP TS 23.003), wherein the 3GPP TS 23.003 provides information related to identification and numbering schemes used in the operator's networks. A technical effect of identifying the subscriber and the UE based on the GPSI is that it facilitates accurate identification of the subscriber, thereby enabling a customised delivery of services based on preferences of at least an individual subscriber.

Optionally, the GPSI comprises at least one public identifier uniquely associated with the subscriber and the UE within the operator's network where the change in the QoS profile is to be applied, wherein the at least one public identifier comprises at least one of: a phone number, an email address, a username, and similar. In this regard, the subscriber is a Subscriber Identity Module (SIM) card in the operator's network, wherein the SIM card is associated with the UE. Examples of the GPSI may include, but are not limited to, Mobile Station Integrated Services Digital Network (MSISDN) number, Mobile Network Code (MNC), Mobile Country Code (MCC). Optionally, the GPSI is stored in a Unified Data Management, UDM, server in the operator's network. Herein, the UDM server emulates a data repository for storing data related to the subscriber and the UE, and performs various functions, for example, such as, subscriber authentication, identity management, service authorization, and similar.

Optionally, the GPSI is mapped to an International Mobile Subscriber Identity, IMSI, number, wherein the IMSI number is stored on the SIM card. Herein, this mapping links the GPSI to the IMSI number, wherein when the UE connects to the operator's network, the GPSI associated with the UE is used to determine the IMSI number associated with the GPSI, which enables identification of the subscriber and the UE.

The new QoS profile will have different values for the attributes related to at least one of: the traffic class, the bandwidth allocation, the priority level, the predefined latency level, the predefined jitter level, the predefined level of packet loss, the at least one rule for traffic shaping and/or policy, to define the level of the requested change in the QoS profile as required by the UE, as compared to values of the attributes already present in the currently provided QoS profile. Optionally, the new QoS profile is created based on a local configuration of the network where the QAS is residing. A technical effect of comparing the request message and the currently provided QoS profile is that it is used to determine how different the new QoS profile will be from the currently provided QoS profile, and also to determine changes required to the currently provided QoS profile in order to create the new QoS profile in a dynamic manner. Another technical effect of comparing the request message and the currently provided QoS profile is that a feasibility of the new QoS profile can be evaluated and determine whether the currently provided QoS profile can be adjusted to create the new QoS profile.

The response message indicates the GPSI of the subscriber and the new QoS profile, which is to be provided to the UE. The operator's network reuses procedures already defined in the specifications of the 3GPP network to implement the change in the QoS profile, so as to provide the new QoS profile to the UE via the NEF. In this regard, the NEF is a third-party gateway to interface the network in which the QAS is residing in, to the UE, in such a way that the UE is able to utilize a framework for QoS of the 3GPP without intervention of the operator's network. Hence, the procedures for implementing the new QoS profile are invoked via the NEF. A technical effect of sending the response message to trigger the requested change in the operator's network is that it enables activation of functions and configurations based on the new QoS profile. This facilitates in synchronizing the QoS parameters and/or configurations across different elements within the operator's network to ensure consistent delivery of services and user experience.

Herein, the response message indicates the subscriber and the UE based on the GPSI, which is sent by the QAS to the NEF. Optionally, the QAS emulates an Application Function (AF) and sends the response message in a form of a Hypertext Transfer Protocol (HTTP) message via a Power-On Self-Test (POST) method to the NEF. The NEF provides a means to securely provide the new QoS profile to the UE by standard air interface messaging procedures already defined in the specifications of the 3GPP network. Optionally, the response message triggers the requested change in the operator's network by signalling internally between elements of the operator's network. As an example, there may be an internal signalling between the NEF and a policy control function (PCF) to trigger the requested change in the operator's network. In an exemplary scenario, the QAS may be configured to send the response message to the NEF, wherein the NEF may assign a reference ID to the response message. The NEF may authorize the response message. The NEF interacts with the PCF and provides the response message to the PCF. Upon authorization of the response message, and if the QAS is trusted by the operator's network, the PCF may send a first notification directly to the QAS. Then, the NEF may send a subscription message to the PCF to subscribe to messages related to a status of resource allocation and may subscribe to at least one event. When a condition of the at least one event is met, and if the QAS is trusted by the operator's network, a second notification may be sent directly to the QAS.

Optionally, a body of the response message comprises at least one of: a QAS identifier, a UE IP address, an IP Flow description, a QoS reference, a notification destination address. A technical effect of providing the aforementioned information in the body of the response message is that the new QoS profile is sent to the UE which requested the change in the QoS. Herein, the term “QAS identifier” refers to a unique label used to identify the QAS residing in the network. An example of the QAS identifier may be, ‘qas-server-01.fi’. The term “UE IP address” refers to an Internet Protocol address of the UE, wherein the IP address is a numeric label assigned to the UE connected to the operator's network. As an example, the UE IP address may be an IPV4 address of the UE i.e., ‘10.10.10.10’. The term “IP Flow description” refers to a set of parameters used to describe a flow of IP packets within the network. Herein, the IP Flow description provides information about at least one of: a source IP address, a destination IP address, a transport protocol, a source port, a destination port. Optionally, a format of the response message follows a syntax of flowDescription for an array, wherein the flowDescription is a description of a flow for the array. An example of the format of the response message may be, [“in”, “UE IP address”, “UE IP port number”, “out”, “destination IP address”, “destination IP port number”, “protocol”]. The term “QoS reference” refers to a specific QoS parameter and/or configuration that is represents a required level of QoS for the UE. As an example, the QoS reference may be ‘turbo’. The term “notification destination address” refers to a specific location where the response message is to be delivered. An example of the notification destination address may be ‘https://100.101.102.103:7070/notifications/v1/sessionid/24480236961 2345’. An example of the format of the response message is provided in the Appendix hereinbelow.

Optionally, upon receiving the request message, the method further comprises configuring the QAS to read a Public Land Mobile Network identifier, PLMN ID, of the UE and for looking up the operator network's NEF IP address. Herein, the PLMN ID refers to a combination of communication services provided wirelessly by the operator's network. In other words, the PLMN ID is another unique identifier that identifies the operator's network via the UE. The IMSI number of the UE typically starts with the PLMN ID, wherein the PLMN ID comprises the MCC and the MNC. In this regard, the QAS is configured to use the PLMN ID of the UE to map said PLMN ID to corresponding NEF IP address within the operator's network. Subsequently, the QAS is configured to initiate a request to the operator's network to retrieve the NEF IP address associated with the PLMN ID. A response is received from the operator's network with the NEF IP address, and optionally, other information related to the NEF IP address. A technical effect of reading the PLMN ID of the UE for looking up the operator network's NEF IP address is that the QAS can be configured to establish connection with the NEF in order to provide the requested change of QoS to the UE.

Optionally, upon receiving the request message, the method further comprises configuring the QAS to compare the new QoS profile with QoS profiles implemented in the NEF to verify if the new QoS profile is feasible. A technical effect of verifying feasibility of the new QoS profile is to determine whether the QAS will be able to provide the required changes under real time conditions of the network. Beneficially, this ensures that network resources of the network where the QAS is residing in is used efficiently, and whether the network will be able to provide the requested change in the QoS for the UE. In this regard, the QAS is configured to compare the new QoS profile with the QoS profiles implemented in the NEF to examine the attributes of the new QoS profile against limitations and/or capabilities of an infrastructure of the operator's network. This comparison further evaluates the feasibility of the new QoS profile by assessing factors, wherein the factors may include at least one of: availability of resources in the operator's network, availability of resources in the network, the specification of the network where the QAS is residing, a capacity of the network, current conditions of the network. Thereafter, based on the comparison and the feasibility, the QAS is, optionally, configured to generate a notification indicative of feasibility of the new QoS profile. This notification is sent to a notification address of the UE, which is present in the request message sent by the UE. Term real time conditions refer to responding to request in a timely manner such as within few seconds (1, 2, 3, 4, 5, 10, 15, 20 sec) or milliseconds (1, 10, 50, 100, 200, 500, 600, 700, 800, 900 msec) or for example integer times (1, 2, 3, 4, 5, 6, 7, 8, 9, 10, 15, 20) round trip time of ping from UE to target application. I.e. feasibility can be application specific for some applications it is sufficient that QoS profile is changed in 1 sec but for others requirement might be lower or higher. Technical effect of this is that it is possible to give priority the QoS profile requests and rollout timing of the requests in respect to other requests.

Optionally, the QoS profiles implemented in the NEF are configured in QAS by local configuration. The QoS profiles implemented in the NEF can be enquired a priori by the UE by using an application programming interface (API) of the QAS, wherein the API may be publicly available.

Optionally, upon receiving the request message, the method further comprises configuring the QAS to form an IP packet flow description based on source/destination IP address and source/destination TCP/UDP port information, or a subset of these, of the UE. In other words, the IP packet flow description is formed based on at least one of: a source IP address, a destination IP address, a source Transmission Control Protocol (TCP)/User Datagram Protocol (UDP), a destination TCP/UDP information, of the UE. Herein, the IP packet comprises information that is transmitted over the operator's network to enable communication between the UE and the UPF. Moreover, the phrase “IP packet flow description” refers to an information that describes characteristics of a particular flow of IP packets within the operator's network. A technical effect of forming the IP packet flow description is that it provides relevant information that helps to identify and classify a flow of traffic within the operator's network which helps determine a time within which the requested change in the QoS can be applied to the UE. Herein, the source IP address refers to an IP address from where the request message originates. Furthermore, the source IP address is used to identify the UE present in the operator's network from which the IP packet is being sent. The destination IP address refers to the IP address refers to an IP address of an intended recipient to which the IP packet is being sent. Herein, the destination IP address specifies the NEF IP address that should receive and process incoming IP packets. The source TCP/UDP protocol refers to a transport layer protocol used by the UE sending the request message. Herein, the source TCP/UDP protocol comprises a source port number which is indicative of a current QoS profile of the UE. The destination TCP/UDP protocol refers to another transport layer protocol used by the UPF that will receive the request message. Herein, the destination TCP/UDP protocol comprises a destination port number which is indicative of the UPF which will receive the request message. It will be appreciated that the TCP/UDP are common transport layer protocols that is used for communication within the operator's network. As an example, when the UE includes reflective QoS support, said reflective QoS support may be taken into account to simplify the IP packet flow description.

Optionally, upon receiving the request message, the method further comprises checking by the QAS if a SponsorInfo description is available or not, and
if the SponsorInfo description is not available, optionally deducing the SponsorInfo description automatically based on at least one of: a LocationInfo description of the UE, a time of day, the GPSI, and
   using the deduced SponsorInfo description or the available SponsorInfo description to set up predetermined charging procedures toward the NEF in the operator's network.

In this regard, the SponsorInfo description is a description of sponsorship information. Herein, the SponsorInfo description comprises details regarding a sponsorship agreement or a sponsorship relationship between the user equipment and the NEF in the operator's network. The sponsorship agreement or a sponsorship relationship is related to a payment process agreed upon by a user associated with the UE prior to or while requesting for a change in the QoS profile currently provided to the UE. The SponsorInfo description may comprise a sponsoring entity (for example, such as, the UE, a home operator). A technical effect of the SponsorInfo description is that it enables the QAS to prioritize providing the requested change in the operator's network so the new QoS profile is provided to the UE in a customized manner. Notably, the QAS is configured in such a manner that even when the SponsorInfo description is not available, said QAS can deduce the SponsorInfo description from information readily available.

In an embodiment, the SponsorInfo description is deduced automatically based on the LocationInfo description of the UE. Herein, the LocationInfo description is a description of location information of the UE, wherein the LocationInfo description is available in the request message sent by the UE (as mentioned earlier). The LocationInfo description is indicative of a geographical location of the UE, wherein a particular geographical location may have a particular sponsorship agreement or a particular sponsorship relationship between the user equipment and the NEF in the operator's network, and comprises the PLMN ID. Optionally, the UE comprises a geolocation sensor, wherein the processor of the UE is configured to receive the geographical location of the UE and process the geographical location to determine the LocationInfo description of the UE. There may be a set of predetermined rules based on reference LocationInfo description of reference devices (for example, other user equipments) within the operator's network. Hence, based on the predetermined rules and the LocationInfo description of the UE, a corresponding SponsorInfo description is determined associated with the geographical location. Consequently, the QAS is configured to set up predetermined charging procedures toward the NEF in the operator's network at that geographical location of the UE.

In another embodiment, the SponsorInfo description is deduced automatically based on the time of the day. In this regard, a particular time of the day may have a particular sponsorship agreement or a particular sponsorship relationship between the user equipment and the NEF in the operator's network. Hence, this may allow provision of different levels of QoS or the predetermined charging procedures based on the time of the day. Herein, the time of the day could be a time instant, a time period, or a time interval. There may another set of predetermined rules based on reference SponsorInfo descriptions associated with reference time of days. Hence, based on the another set of predetermined rules and the time of the day, a corresponding SponsorInfo description is determined. Consequently, the QAS is configured to set up predetermined charging procedures toward the NEF in the operator's network at that time of the day. As an example, predetermined charging procedures toward the NEF in the operator's network may be high during peak hours.

In yet another embodiment, the SponsorInfo description is deduced automatically based on GPSI. In this regard, a particular GPSI may have a particular sponsorship agreement or a particular sponsorship relationship between the user equipment and the NEF in the operator's network. There may yet another set of predetermined rules based on relationships between reference SponsorInfo descriptions the GPSIs in the operator's network. Hence, based on the yet another set of the predetermined rules and the GPSI, a corresponding SponsorInfo description is determined. Consequently, the QAS is configured to set up predetermined charging procedures toward the NEF in the operator's based on the GPSI associated with the UE.

Herein, the term “predetermined charging procedure” refers to any of: a rental charging procedure, a usage charging procedure, which is charged by the NEF in the operator's network, for providing the requested change in the operator's network. Herein, the rental charging procedure may comprise charges applied on the UE for a time period, wherein the time period may be a week, a month, a year, and the like. The usage charging procedure may comprise charges applied on the UE based on services utilized.

Optionally, the method further comprises configuring the QAS by using the subscriber and a UE information for checking eligibility of the UE for said predetermined charging procedures. A technical effect of checking the eligibility of the UE to determine whether the UE meets a prerequisite criteria necessary to qualify for the predetermined charging procedures. Herein, the term “UE information” refers to information specific to the UE, wherein said information comprises at least one of: a type, a capability, a firmware version, of the UE. Optionally, the QAS is further configured to map the subscriber and the UE information to corresponding SponsorInfo descriptions, wherein the mapping enables identification of the predetermined charging procedure based on a profile of the subscriber and at least one characteristic of the UE. In this regard, an impact of the subscriber and the UE information on the eligibility of the UE for the predetermined charging procedures is determined based on various factors, for example, such as, a service plan feature, a compatibility of the UE, a category of the subscriber, and similar. When the UE is eligible, the predetermined charging procedures which is appropriate for the UE is applied.

Optionally, the method further comprises configuring the QAS for determining the eligibility of a local sponsor that is based on the LocationInfo description. Herein, the local sponsor is an entity that has a sponsorship agreement with the operator's network to provide the requested change in the operator's network within a particular geographical location and/or the PLMN ID of the UE. This particular geographical information is provided in the LocationInfo description in the request message sent by the UE. A technical effect of determining the eligibility of the local sponsor is that the requested change in the QoS profile currently provided to the UE is triggered to make the new QoS profile available to the UE within that particular geographical location. For example, a local sponsor may be a festival organizer, wherein the festival organizer may want to offer a better QoS than existing QoS for selected UEs.

The present disclosure also related to the second aspect as described above. Various embodiments and variants disclosed above, with respect to the aforementioned first aspect, apply mutatis mutandis to the second aspect.

It will be appreciated that the Application Server is configured to host associated services and application for the single application or the group of applications. The Application Server is communicably coupled with the UE operating system, the QAS and the NEF. A technical effect of the Application Server itself sending the request message is that the QoS of the UE is automatically changed without a need of contacting the NEF of every operator's network where the UE might be residing. Optionally, the Application Server is communicably coupled to the UPF, wherein the UE sends the request message to the Application Server via the UPF.

Optionally, the method further comprises:
receiving a plurality of request messages, from a plurality of UEs operating in a plurality of operator's networks via the UPF, by the QAS, residing in the network reachable by the plurality of UEs, to request a change in a plurality of QoS profiles currently provided to the plurality of UEs;
identifying, based on the plurality of request messages, each subscriber and each UE based on each GPSI, associated with the plurality of UEs;
creating a new QoS profile based on each request message from amongst the plurality of request messages, by comparing each request message and each currently provided QoS profile for each of the UE from amongst the plurality of UEs of each of the subscriber; and
sending a plurality of response messages, each of the plurality of response messages comprising the new QoS profile for each of the UE of each of the subscriber, by the QAS to a plurality of NEFs, to trigger the requested change in each of the plurality of operator's networks.

Optionally, at least one of the plurality of request messages indicates a single application or a group of applications, running in each operating system of each of the plurality of UEs. Herein, an information of the single application or the group of applications may be present in the Application Server residing in the same network where the QAS is residing.

The present disclosure also related to the third aspect and the fourth aspect as described above. Various embodiments and variants disclosed above, with respect to the aforementioned first and the second aspect, apply mutatis mutandis to the third and the fourth aspect.

Optionally, upon receiving the request message, the QAS is further configured to read a Public Land Mobile Network identifier, PLMN ID, of the UE and for looking up the operator network's NEF IP address.

Optionally, upon receiving the request message, the QAS is further configured to compare the new QoS profile with QoS profiles implemented in the NEF to verify if the new QoS profile is feasible.

Optionally, upon receiving the request message, the QAS is further configured to form an IP packet flow description based on source/destination IP address and source/destination TCP/UDP port information, or a subset of these, of the UE.

Optionally, upon receiving the request message, the QAS is further configured to check if a SponsorInfo description is available or not, and
if the SponsorInfo description is not available, optionally deduce the SponsorInfo description automatically based on at least one of: a LocationInfo description of the UE, a time of day, the GPSI, and
   use the deduced SponsorInfo description or the available SponsorInfo description to set up predetermined charging procedures toward the NEF in the operator's network.

Optionally, the QAS is further configured by using the subscriber and the UE information to check eligibility of the UE for said predetermined charging procedures.

Optionally, the QAS is further configured to determine the eligibility of a local sponsor that is based on the LocationInfo description.

Optionally, a body of the response message comprises at least one of: a QAS identifier, a UE IP address, an IP Flow description, a QoS reference, a notification destination address.

Optionally, the request message indicates a single application or a group of applications, running in an operating system of the UE.

Optionally, the network the QAS is residing in is a 3rd Generation Partnership Project, 3GPP, network that supports the NEF.

APPENDIX

| | |
|---|---|
| 1. | Hereinbelow, there is provided an example of the format of the |

```
request message.
Header = :path: /qas-server-01.fi/qas-as-session-with-qos/v1
Header = ueId: “msisdn-358405561866”
application/json
{
  “dnn”: “internet”,
  “gpsi”: “msisdn-358405561866”,
“plmnId”: {
```

“mcc”: “244”,
“mnc”: “05”

}
“LocationInfo”: {

“cellId”: “12948607014”,

}
“ueIpv4Addr”: “10.10.10.10”,
“qosReference”: “turbo”
“reflectiveQosSupported”: “true”
“usageThreshold”: “1hr”
“sponsorInfo”: “self-paid”
“notificationDestination:
“https://10.10.10.10:7070/notifications/v1/sessionid/123498765123”,
}

| | |
|---|---|
| 2. | Hereinbelow, there is provided an example of the request message |

```
indicating the single application or the group of applications.
Header = :path: /elisa-nef.fi/3gpp-as-session-with-qos/v1
Header = scsAsId: “qas-server-01.fi”
application/json
{
  “dnn”: “internet”,
  “gpsi”: “msisdn-358405561866”,
  “ueIpv4Addr”: “10.10.10.10”,
  “exterAppId”: “0x454E5445525052495345”,
  “ FlowInfo”: {
```

“flowId”: “1”,
“flowDescriptions”: [“in”, “10.10.10.10”, “any”, “any”, “any”, “out”,

“any”, “any”, “10.10.10.10”, “any”, “any”]
},
“LocationInfo”: {

“cellId”: “12948607014”,

}
“qosReference”: “gbr-5mbps”
“reflectiveQos”: “true”
“notificationDestination:
“https://100.101.102.103:7070/notifications/v1/sessionid/2448023696
12345”,
}

| | |
|---|---|
| 3. | Hereinbelow, there is provided an example of the format of the |

```
response message.
Header = :path: /elisa-nef.fi/3gpp-as-session-with-qos/v1
Header = scsAsId: “qas-server-01.fi”
application/json
{
  “dnn”: “internet”,
  “gpsi”: “msisdn-358405561866”,
  “ueIpv4Addr”: “10.10.10.10”,
  “FlowInfo”: {
```

“flowId”: “1”,
“flowDescriptions”: [“in”, “10.10.10.10”, “any”, “any”, “any”, “out”,

“any”, “any”, “10.10.10.10”, “any”, “any”]
},
“LocationInfo”: {

“cellId”: “12948607014”,

}
“qosReference”: “turbo”
“reflectiveQos”: “true”
“notificationDestination:
“https://100.101.102.103:7070/notifications/v1/sessionid/2448023696
12345”,
}

### DETAILED DESCRIPTION OF THE DRAWINGS

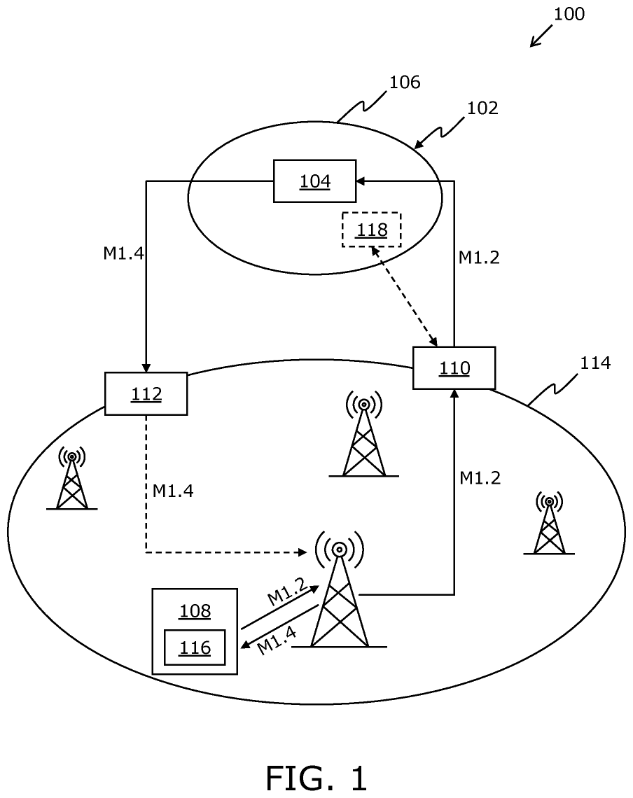

Referring to FIG. 1, there is shown a schematic illustration of an environment 100 in which a system 102 is used, in accordance with an embodiment of the present disclosure. The system comprises a Quality Assurance Server (QAS) 104 residing in a network 106. The environment 100 comprises the system 102, a User Equipment (UE) 108, a User Plane Function (UPF) 110, and a Network Exposure Function (NEF) 112. The QAS 104 is communicably coupled to the UE 108. Herein, the UE 108 operates in an operator's network 114, and the network 106 is reachable by the UE 108. The network 106 in which the QAS 104 resides in, is separate from the operator's network 114. The UPF 110 and the NEF 112 reside in the operator's network 114. The QAS 104 is configured to receive a request message (as shown by an arrow-head line M1.2) from the UE 108 via the UPF 110, to request a change in a Quality of Service, QoS, profile currently provided to the UE 108. Subsequently, the QAS 104 is configured to identify, based on the request message M1.2, a subscriber and the UE 108 based on a Generic Public Subscriber Identifier, GPSI, associated with the UE 108. Herein, the subscriber may be a Subscriber Identity Module card of the UE 108. Subsequently, the QAS 104 is configured to create a new QoS profile based on the request message M1.2, by comparing the request message M1.2 and the currently provided QoS profile for the UE 108 of the subscriber. Finally, the QAS 104 is configured to send a response message (as shown by an arrow-head line M1.4), the response message M1.4 comprising the new QoS profile for the UE 108 of the subscriber, to the NEF 112, to trigger the requested change in the operator's network 114.

Optionally, the UE 108 comprises an operating system 116. The request message M1.2 sent by the UE 108 indicates a single application or a group of applications, running in the operating system 116 of the UE 108. Optionally, the system 102 comprises an Application Server 118 residing in the network 106, wherein the Application Server 118 is communicably coupled to the UPF 110. Herein, the request message M1.2 may indicate a single application or a group of applications, running the operating system 116 of the UE, wherein the Application Server 118 comprises information regarding said single application or said group of applications.

FIG. 1 is merely an example, which should not unduly limit the scope of the claims herein. A person skilled in the art will recognize many variations, alternatives, and modifications of embodiments of the present disclosure.

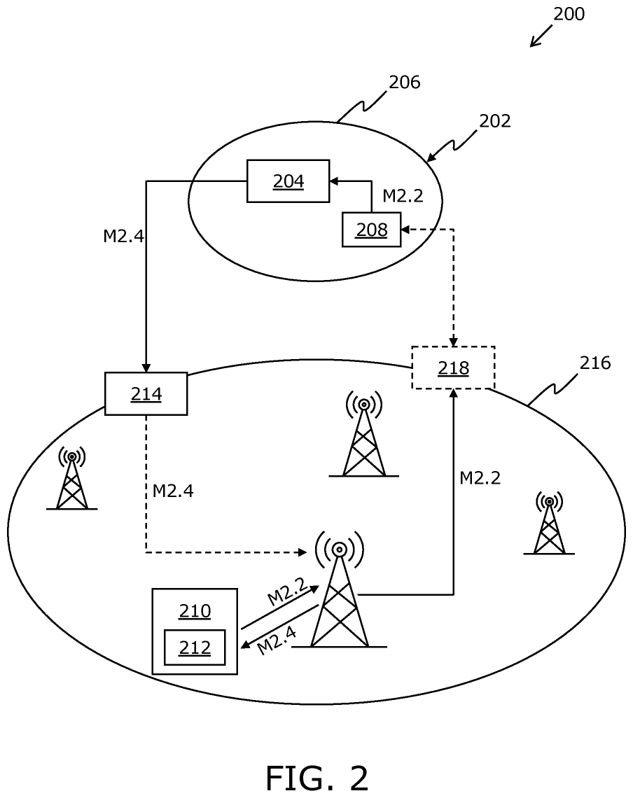

Referring to FIG. 2, there is shown a schematic illustration of an environment 200 in which a system 202 is used, in accordance with an embodiment of the present disclosure. The system 202 comprises a Quality Assurance server (QAS) 204 residing in a network 206. The environment 200 comprises the system 202, an Application Server 208, a User Equipment (UE) 210, an operating system 212 of the UE 210, and a Network Exposure Function (NEF) 214. The QAS 204 is communicably coupled with the Application Server 208 and the User Equipment 210. Herein, the Application Server 208 resides in the network 206, the UE 210 operates in an operator's network 216, and the NEF 214 resides in the operator's network 216. The QAS 204 is configured to receive a request message (as shown by an arrow-head line M2.2) from the Application Server 208 to request a change in a Quality of Service QoS profile currently provided to the UE 210. Herein, the Application Server 208 comprises information on a single application or a group of applications, running in the operating system 212 of the UE 210. Subsequently, the QAS 204 is configured to identify, based on the request message M2.2, a subscriber and the UE 210 based on a Generic Public Subscriber Identifier (GPSI) associated with the UE 210. Subsequently, the QAS 204 is configured to create a new QoS profile based on the request message M2.2, by comparing the request message M2.2 and currently provided QoS profile for the UE 210 of the subscriber. Finally, the QAS 204 is configured to send a response message M2.4, the response message (as shown by an arrow-head line M2.4) comprising the new QoS profile for the UE 210 of the subscriber, to the NEF 214, to trigger the requested change in the operator's network 216. Optionally, the environment 200 further comprises a User Plane Function (UPF) 218, wherein the UPF 218 also resides in the operator's network 216. Herein, the request message M2.2 from the UE 210 is sent via the UPF 218 to the Application Server 208.

FIG. 2 is merely an example, which should not unduly limit the scope of the claims herein. A person skilled in the art will recognize many variations, alternatives, and modifications of embodiments of the present disclosure.

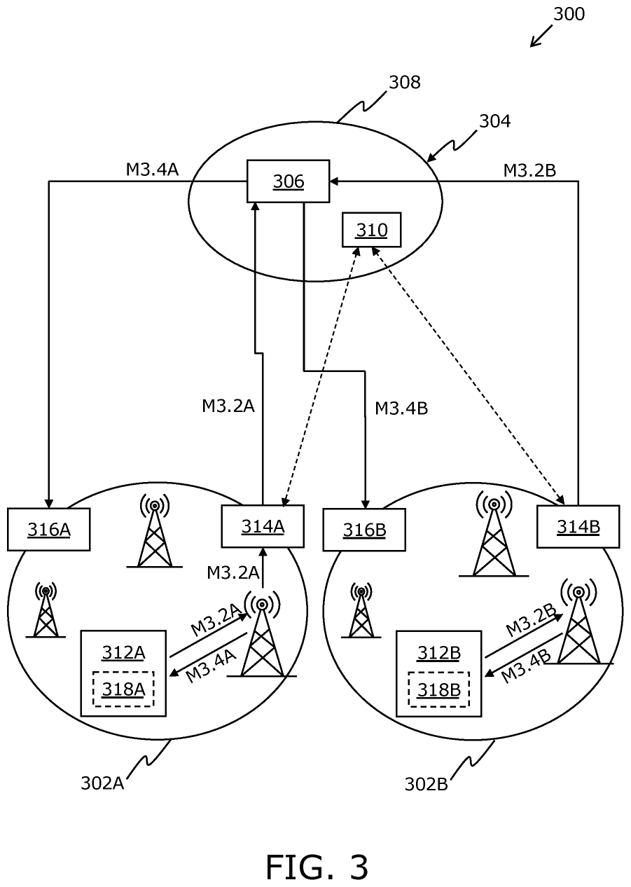

Referring to FIG. 3, there is shown a schematic illustration of an environment 300 comprising a plurality of operator networks (as shown by two operator networks 302A and 302B) in which a system 304 is used, in accordance with another embodiment of the present disclosure. The system 304 comprises a Quality Assurance Server (QAS) 306 residing in a network 308. The environment comprises an Application Server 310, a plurality of User Equipments (UEs) (as depicted by two UEs 312A and 312B), a plurality of User Plane Functions (UPFs) (as depicted by two UPFs 314A and 314B), and a plurality of Network Exposure Functions (NEFs) (as depicted by two NEFs 316A and 316B). The QAS 306 is communicably coupled to the two UEs 312A-B. Herein, the Application Server 310 resides in the network 308, the UE 310A operates in the operator network 302A, the UE 310B operates in the operator network 302B, the UPF 314A and NEF 316A reside in the operator network 302A, and the UPF 314B and NEF 316B reside in the operator network 302B. The QAS 306 is configured to receive a plurality of request messages (as depicted by two request messages M3.2A and M3.2B), from the two UEs 312A and 312B via the two UPFs 314A and 314B, respectively, to request a change in a plurality of QoS profiles currently provided to the two UEs 312A-B. Subsequently, the QAS 306 is configured to identify, based on the two request messages M3.2A-B, each subscriber and each UE based on each GPSI, associated with the two UEs 312A-B. Subsequently, the QAS 306 is configured to create a new QoS profile, based on each request message from amongst the two request messages M3.2A-B, by comparing each request message and each currently provided QoS profile for each of the UE from amongst the two UEs 312A-B of each of the subscriber. Subsequently, the QAS 306 is configured to send a plurality of response messages (as shown by two response messages M3.4A and M3.4B), each of the plurality of response messages M3.4A-B comprising the new QoS profile for each of the UE of each of the subscriber, to the two NEFs 316A-B, respectively, to trigger the requested change in each of the plurality of operator's networks 302A-B.

Optionally, the UE 312A comprises an operating system 318A and the UE 312B comprises an operating system 318B. Herein, the two request messages M3.2A-B may indicate a single application or a group of applications, running in the two operating systems 318A-B of the two UEs 312A-B. Herein, an information of the single application or the group of applications may be present in the Application Server 310 residing in the network 308.

FIG. 3 is merely an example, which should not unduly limit the scope of the claims herein. A person skilled in the art will recognize many variations, alternatives, and modifications of embodiments of the present disclosure.

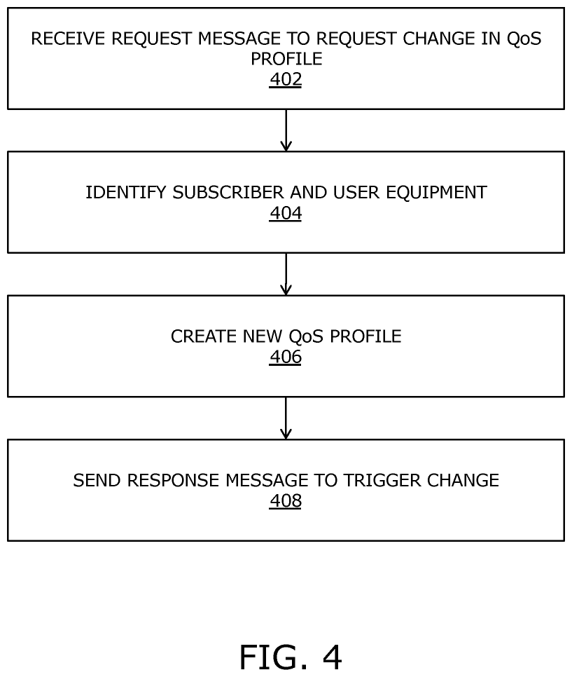

Referring to FIG. 4, illustrated are steps of a method for centrally managed end user-controlled quality of service, in accordance with an embodiment of the present disclosure. At step 402, a request message is received from a User Equipment, UE via a User Plane Function, UPF, by a Quality Assurance Server, QAS, to request a change in a Quality of Service, Qos, profile currently provided to the UE. Herein, the UE operates in an operator's network via a User Plane Function, UPF, and the QAS resides in a network which is separate from the operator's network, reachable by the UE. At step 404, based on the request message, a subscriber and the UE are identified based on a Generic Public Subscriber Identifier, GPSI, associated with the UE. At step 406, a new QoS profile is created based on the request message, by comparing the request message and the currently provided QoS profile for the UE of the subscriber. At step 408, a response message is sent by the QAS to a Network Exposure Function, NEF, to trigger the requested change in the operator's network, wherein the response message comprises the new QoS profile for the UE of the subscriber. Furthermore, alternatively, for creating a new QoS profile based on the request message the new QoS profile can be pre-configured to QAS and/or NEF. In said scenario the QoS profile is selected from a group of pre-configured profiles. The profiles are in essence agreed and configured to network beforehand based on type of profile available by operator (of NEF) to 3rd parties. Benefit of that arrangement is to provide better predictability than in totally dynamic model.

The aforementioned steps are only illustrative and other alternatives can also be provided where one or more steps are added, one or more steps are removed, or one or more steps are provided in a different sequence without departing from the scope of the claims herein.

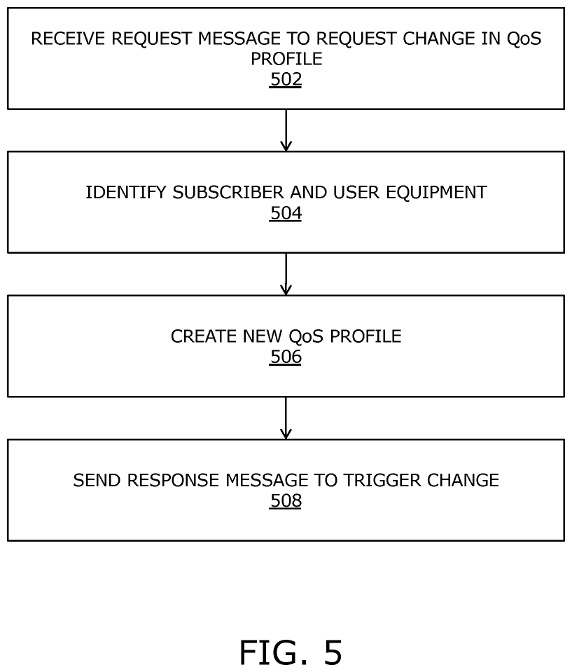

Referring to FIG. 5, illustrated are steps of a method for centrally managed end user-controlled quality of service, in accordance with an embodiment of the present disclosure. At step 502, a request message is received, from an Application Server by a Quality Assurance Server, QAS, to request a change in a Quality of Service, Qos, profile currently provided to a User Equipment, UE. Herein, the Application Server and the QAS reside in a same network, the Application Server has information on a single application or a group of applications, running in a UE operating system. At step 504, based on the request message, a subscriber and the UE are identified based on a Generic Public Subscriber Identifier, GPSI, associated with the UE. At step 506, a new QoS profile is created based on the request message, by comparing the request message and currently provided QoS profile for the UE of the subscriber. At step 508, a response message is sent by the QAS to a Network Exposure Function, NEF, to trigger the requested change in the operator's network, wherein the response message comprises the new QoS profile for the UE of the subscriber. As discussed earlier, QoS profile(s) can be preset, and provided based on the request message.

The aforementioned steps are only illustrative and other alternatives can also be provided where one or more steps are added, one or more steps are removed, or one or more steps are provided in a different sequence without departing from the scope of the claims herein.

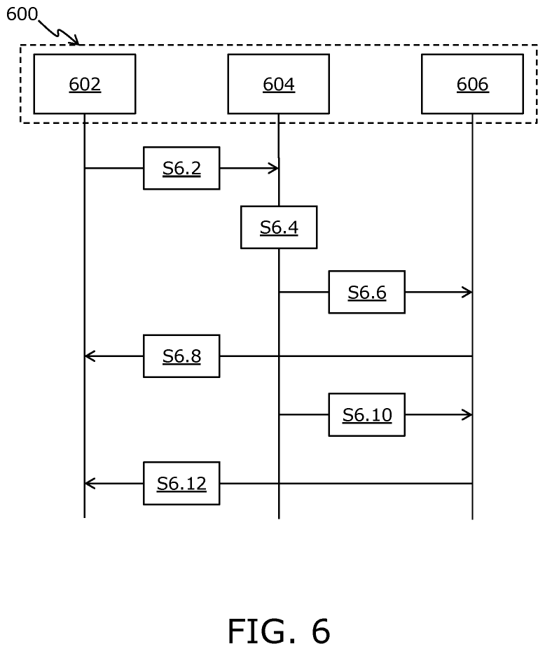

Referring to FIG. 6, there is shown a sequence diagram illustrating operational steps of an exemplary system 600. The system 600 comprises a Quality Assurance Server (QAS) 602, a Network Exposure Function (NEF) 604, and a Policy Control Function (PCF) 606. The QAS 602 and the PCF 606 reside in a network, and the NEF 604 resides in an operator's network. At step S6.2, a response is sent from the QAS 602 to the NEF 604, wherein the NEF 604 assigns a reference ID to the response message. At step 6.4, the NEF 604 authorizes the response message. At step 6.6, the NEF 604 interacts with the PCF 606 and provides the response message to the PCF 606. At step 6.8, upon authorization of the response message, and if the QAS 602 is trusted by the operator's network, the PCF 606 sends a first notification directly to the QAS 602. At step 6.10, the NEF 604 may send a subscription message to the PCF 606 to subscribe to messages related to a status of resource allocation and may subscribe to at least one event. At step 6.12, when a condition of the at least one event is met, and if the QAS 602 is trusted by the operator's network, a second notification may be sent directly to the QAS 602.

FIG. 6 is merely an example, which should not unduly limit the scope of the claims herein. A person skilled in the art will recognize many variations, alternatives, and modifications of embodiments of the present disclosure.

1. A method comprising:
receiving, a request message (M1.2, M3.2A-B), from a User Equipment, UE, operating in an operator's network via a User Plane Function, UPF, by a Quality Assurance Server, QAS, residing in a network which is separate from the operator's network, reachable by the UE, to request a change in a Quality of Service, QoS, profile currently provided to the UE, wherein upon receiving the request message (M1.2, M3.2A-B):
checking by the QAS if a SponsorInfo description is available or not, and
if the SponsorInfo description is not available, optionally deducing the SponsorInfo description automatically based on at least one of: a LocationInfo description of the UE, a time of day, the GPSI, and
using the deduced SponsorInfo description or the available SponsorInfo description to set up predetermined charging procedures toward the NEF (112, 214, 316A) in the operator's network;
identifying, based on the request message, a subscriber and the UE based on a Generic Public Subscriber Identifier, GPSI, associated with the UE;
creating a new QoS profile based on the request message, by comparing the request message and the currently provided QoS profile for the UE of the subscriber; and
sending a response message (M1.4, M2.4, M3.4A-B), the response message comprising the new QoS profile for the UE of the subscriber, by the QAS to a Network Exposure Function, NEF, to trigger the requested change in the operator's network.

2. A method according to claim 1, wherein upon receiving the request message (M1.2, M3.2A-B), the method further comprises configuring the QAS to read a Public Land Mobile Network identifier, PLMN ID, of the UE and for looking up the operator network's NEF IP address.

3. A method according to claim 1, wherein upon receiving the request message (M1.2, M3.2A-B), the method further comprises configuring the QAS to compare the new QoS profile with QoS profiles implemented in the NEF to verify if the new QoS profile is feasible.

4. A method according to claim 1, wherein upon receiving the request message (M1.2, M3.2A-B), the method further comprises configuring the QAS to form an IP packet flow description based on source/destination IP address and source/destination TCP/UDP port information, or a subset of these, of the UE.

5. (canceled)

6. A method according to claim 45, further comprising configuring the QAS by using the subscriber and the UE information for checking eligibility of the UE for said predetermined charging procedures.

7. A method according to claim 4, further comprising configuring the QAS for determining the eligibility of a local sponsor that is based on the LocationInfo description.

8. A method according to claim 1, wherein a body of the response message (M1.4, M2.4, M3.4A-B) comprises at least one of: a QAS identifier, a UE IP address, an IP Flow description, a QoS reference, a notification destination address.

9. A method according to claim 1, wherein the request message (M1.2, M3.2A-B) indicates a single application or a group of applications, running in an operating system of the UE.

10. A method comprising:
receiving, a request message (M2.2), from an Application Server by a Quality Assurance Server, QAS, the Application Server and the QAS residing in a same network, the Application Server having an information on a single application or a group of applications, running in a UE operating system, to request a change in a Quality of Service, QoS, profile currently provided to a User Equipment, UE; wherein upon receiving the request message (M1.2, M3.2A-B),
checking by the QAS if a SponsorInfo description is available or not, and
if the SponsorInfo description is not available, optionally deducing the SponsorInfo description automatically based on at least one of: a LocationInfo description of the UE, a time of day, the GPSI, and
using the deduced SponsorInfo description or the available SponsorInfo description to set up predetermined charging procedures toward the NEF in the operator's network;
identifying, based on the request message, a subscriber and the UE based on a Generic Public Subscriber Identifier, GPSI, associated with the UE;
creating a new QoS profile based on the request message, by comparing the request message and currently provided QoS profile for the UE of the subscriber; and
sending a response message (M1.4, M2.4, M3.4A-B), the response message comprising the new QoS profile for the UE of the subscriber, by the QAS to a Network Exposure Function, NEF, to trigger the requested change in an operator's network where the UE is operating therein.

11. A method according to claim 1, wherein the network the QAS is residing in is a 3rd Generation Partnership Project, 3GPP, network that supports the NEF.

12-13. (canceled)

14. A method according to claim 9, wherein the network the QAS is residing in is a 3rd Generation Partnership Project, 3GPP, network that supports the NEF.

15. A system comprising a Quality Assurance Server, QAS, that is communicably coupled to a User Equipment, UE, operating in an operator's network, the QAS residing in a network which is separate from the operator's network, reachable by the UE, wherein the QAS is configured to:
receive a request message (M1.2, M3.2A-B) from the UE via a User Plane Function, UPF, to request a change in a Quality of Service, QoS, profile currently provided to the UE;
check if a SponsorInfo description is available or not, and
if the SponsorInfo description is not available, optionally to deduce the SponsorInfo description automatically based on at least one of: a LocationInfo description of the UE, a time of day, the GPSI, and
use the deduced SponsorInfo description or the available SponsorInfo description to set up predetermined charging procedures toward the NEF in the operator's network;
identify, based on the request message, a subscriber and the UE based on a Generic Public Subscriber Identifier, GPSI, associated with the UE;
create a new QoS profile based on the request message, by comparing the request message and the currently provided QoS profile for the UE of the subscriber; and
send a response message (M1.4, M2.4, M3.4A-B), the response message comprising the new QoS profile for the UE of the subscriber, to a Network Exposure Function, NEF, to trigger the requested change in the operator's network.

16. A system comprising a Quality Assurance Server QAS, wherein the QAS is configured to:
receive a request message (M2.2A) from an Application Server, wherein the QAS and the Application Server reside in a same network, the Application Server comprising an information on a single application or a group of applications, running in an operating system of a User Equipment, UE, to request a change in a Quality of Service QoS profile currently provided to the UE;
check if a SponsorInfo description is available or not, and
if the SponsorInfo description is not available, optionally to deduce the SponsorInfo description automatically based on at least one of: a LocationInfo description of the UE, a time of day, the GPSI, and
use the deduced SponsorInfo description or the available SponsorInfo description to set up predetermined charging procedures toward the NEF in the operator's network;
identify, based on the request message, a subscriber and the UE based on a Generic Public Subscriber Identifier GPSI associated with the UE;
create a new QoS profile based on the request message, by comparing the request message and currently provided QoS profile for the UE of the subscriber; and
send a response message (M1.4, M2.4, M3.4A-B), the response message comprising the new QoS profile for the UE of the subscriber, to a Network Exposure Function NEF, to trigger the requested change in an operator's network where the UE operates therein.
